(19) United States
(12) Patent Application Publication
(10) Pub. No.: US 2026/0124948 A1
(43) Pub. Date: May 7, 2026

(54) VEHICLE SYSTEMS AND METHODS FOR COMPENSATING SCHEDULED BATTERY CHARGING

(71) Applicant: GM GLOBAL TECHNOLOGY OPERATIONS LLC, Detroit, MI (US)

(72) Inventors: Cameron Christopher ROSE, Heiskell, TN (US); Paul Guillermo Otanez, Franklin, MI (US)

(21) Appl. No.: 18/934,881

(22) Filed: Nov. 1, 2024

(51) Int. Cl. B60L 53/66; B60L 53/30

(52) U.S. Cl. CPC B60L 53/66; B60L 53/305

(57) ABSTRACT

A vehicle system includes a database and a control module. The control module is configured to determine a plurality of compensation factors for a plurality of planned charge power values, each compensation factor determined based on a system weight and an error between an estimated energy provided for a charging timeslot and an actual energy provided during the charging timeslot for charging a battery in a vehicle, store, in the database, each of the plurality of compensation factors specific to one of the planned charge power values, select one of the stored compensation factors from the database based on a subsequent planned charge power value for charging the battery in the vehicle, and determine an adjusted time duration for charging the battery in the vehicle based on the selected compensation factor. Other example vehicle systems and control methods are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle systems and methods for compensating scheduled battery charging, and more particular to vehicle systems and methods for compensating scheduled battery charging based on timeslot energy.

An electric vehicle (EV), such as a pure EV, a plug-in hybrid EV, etc. includes a battery system and one or more electric machines. The battery system is a rechargeable energy storage system including one or more high voltage battery packs each having a collection of battery cells. To charge the battery system, a charger plug is electrically coupled to a charging port of the EV via one or more connectors. In some instances, an estimated time duration for charging the battery system may be provided. For example, when a user plugs the charger plug into the charging port and charging begins, sensors may detect a current and a voltage provided to the EV. Based on the current and the voltage, power can be calculated. Then, a time duration may be estimated with the calculated power and a known energy needed to charge the battery system. In some scenarios, time duration estimates may be altered after completion of a charging session.

### SUMMARY

A vehicle system for improving time duration estimates for charging a battery in a vehicle based on a charging schedule including charging timeslots is disclosed. Each charging timeslot has an estimated time duration and a corresponding planned charge power value. The vehicle system includes a database, and a control module in communication with the database. The control module is configured to determine a plurality of compensation factors for a plurality of planned charge power values, each compensation factor determined based on a system weight and an error between an estimated energy provided for a charging timeslot of the charging timeslots and an actual energy provided during the charging timeslot for charging the battery in the vehicle, store, in the database, each of the plurality of compensation factors specific to one of the planned charge power values, select one of the stored compensation factors from the database based on a subsequent planned charge power value for charging the battery in the vehicle, and determine an adjusted time duration for charging the battery in the vehicle based on the selected compensation factor.

In other features, the vehicle system further includes a vehicle charging control module positioned in the vehicle and in communication with the control module. The vehicle charging control module is configured to schedule a charging session for the battery in the vehicle based on the adjusted time duration and control charging of the battery in response to the scheduled charging session.

In other features, the vehicle charging control module is configured to schedule the charging session based on the adjusted time duration and a defined charge competition time for the battery.

In other features, the vehicle charging control module is configured to schedule the charging session based on the adjusted time duration and off-peak hours for a power system to charge the battery.

In other features, the vehicle system further includes a display module positioned in the vehicle and in communication with the control module. The display module is configured to receive the adjusted time duration for charging the battery in the vehicle and display the adjusted time duration.

In other features, the vehicle system further includes a vehicle charging control module positioned in the vehicle. The display module is configured to display an input selectable by a user to indicate approval of the adjusted time duration. The vehicle charging control module is configured to control charging of the battery in the vehicle in response to the user selecting the input indicating approval of the adjusted time duration.

In other features, the control module is configured to determine at least one of the compensation factors based on a previous compensation factor for the same planned charge power value.

In other features, the control module is configured to determine an adjusted energy based on the estimated energy and the selected compensation factor and determine the adjusted time duration for charging the battery in the vehicle based on the adjusted energy.

In other features, the control module is configured to determine the system weight based on one or more conditions associated with charging the battery in the vehicle.

In other features, the one or more conditions includes at least one of a time duration factor, an energy factor, a battery temperature factor, a battery state of health factor, a charging current type factor, and a charging location factor.

In other features, the control module is configured to assign weight values for the one or more conditions and determine the system based on the one or more conditions and their assigned weight values.

In other features, the control module is configured to determine the estimated energy provided for the charging timeslot based on the estimated time duration and the corresponding planned charge power value specific to the charging timeslot and determine the actual energy provided during the charging timeslot based on an actual charge power value and an actual time duration for charging the battery in the vehicle.

A vehicle system for improving time duration estimates for charging a battery in a vehicle based on a charging schedule including charging timeslots is disclosed. Each charging timeslot has an estimated time duration and a corresponding planned charge power value. The vehicle system includes a database configured to store a plurality of compensation factors for a plurality of planned charge power values, and a control module in communication with the database. The control module is configured to determine an estimated energy provided for a charging timeslot of the charging timeslots based on the estimated time duration and the corresponding planned charge power value specific to the charging timeslot, determine an actual energy provided during the charging timeslot based on an actual charge power value and an actual time duration for charging the battery in the vehicle, determine an error between the estimated energy and the actual energy, determine a system weight based on one or more conditions associated with charging of a battery in the vehicle, determine a compensation factor for the planned charge power value based on the system weight and the error, store, in the database, the compensation factor specific to the planned charge power value, select one of the stored compensation factors from the database based on a subsequent planned charge power value, determine an adjusted energy based on the estimated energy and the selected compensation factor, and determine an adjusted time duration for the subsequent planned charge power value based on the adjusted energy.

In other features, the vehicle system further includes a vehicle charging control module positioned in the vehicle and in communication with the control module. The vehicle charging control module is configured to schedule a charging session for the battery in the vehicle based on the adjusted time duration and control charging of the battery in response to the scheduled charging session.

In other features, the vehicle charging control module is configured to schedule the charging session based on the adjusted time duration and one of a defined charge competition time for the battery or off-peak hours for a power system to charge the battery.

In other features, the vehicle system further includes a display module positioned in the vehicle and in communication with the control module. The display module is configured to receive the adjusted time duration for charging the battery in the vehicle, and display the adjusted time duration and an input selectable by a user to indicate approval of the adjusted time duration

In other features, the vehicle system further includes a vehicle charging control module positioned in the vehicle and in communication with the control module. The vehicle charging control module is configured to control charging of the battery in the vehicle in response to the user selecting the input indicating approval of the adjusted time duration.

In other features, the control module is configured to determine the compensation factor based on a previous compensation factor specific to the planned charge power value.

A charging control method for improving time duration estimates for charging a battery in a vehicle based on a charging schedule including charging timeslots is disclosed. Each charging timeslot has an estimated time duration and a corresponding planned charge power value. The charging control method includes determining a plurality of compensation factors for a plurality of planned charge power values, each compensation factor determined based on a system weight and an error between an estimated energy provided for a charging timeslot of the charging timeslots in the charging schedule and an actual energy provided during the charging timeslot for charging the battery in the vehicle, storing, in a database, each of the plurality of compensation factors specific to one of the planned charge power values, selecting one of the stored compensation factors from the database based on a subsequent planned charge power value for charging the battery in the vehicle, determining an adjusted time duration for charging the battery in the vehicle based on the selected compensation factor, and charging of the battery in the vehicle based on the adjusted time duration.

In other features, the charging control method further includes displaying the adjusted time duration and an input selectable by a user to indicate approval of the adjusted time duration.

In other features, charging of the battery in the vehicle includes charging of the battery in response to the input indicating approval of the adjusted time duration.

In other features, the charging control method further includes scheduling a charging session for the battery in the vehicle based on the adjusted time duration and one of a defined charge competition time for the battery or off-peak hours for a power system to charge the battery.

In other features, charging of the battery in the vehicle includes charging of the battery in the vehicle controlling charging of the battery in response to the charging session.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram of an example vehicle system for improving time duration estimates for charging a battery in a vehicle, according to the present disclosure;

FIG. 2 is a flowchart of an example charging control method for improving time duration estimates for charging a battery in a vehicle, according to the present disclosure;

FIG. 3 is a flowchart of another example charging control method for improving time duration estimates for charging a battery in a vehicle, according to the present disclosure;

FIG. 4 is a flowchart of another example charging control method for improving time duration estimates for charging a battery in a vehicle, according to the present disclosure; and

FIGS. 5-6 is a flowchart of another example charging control method for improving time duration estimates for charging a battery in a vehicle, according to the present disclosure.

In the drawings, reference numbers may be reused to identify similar and/or identical elements.

### DETAILED DESCRIPTION

Electric vehicles (EVs), such as pure EVs, plug-in hybrid EVs, etc. include a battery system having one or more high voltage rechargeable battery packs. Time durations for charging the battery system in an EV can be estimated based on a known energy needed to charge the battery system and a calculated power provided to the EV during a charging session. However, such estimated time durations in the charging schedule are often inaccurate and therefore unreliable.

The vehicle charging systems and charging control methods according to the present disclosure provide solutions for improving time duration estimates given a charge schedule for charging a battery or battery packs in a vehicle. For example, and as further explained herein, the vehicle charging systems and methods may improve time duration estimates by determining compensation factors each based on a system weight and an error between an estimated energy provided for a charging timeslot and an actual energy provided during the charging timeslot for charging the battery in the vehicle, and then utilizing one of the compensations factors to adjust the estimated energy need and determine an improved estimated time duration for charging the battery in the vehicle. In doing so, users (e.g., drivers, vehicle owners, etc.) are provided accurate charge times regardless of conditions associated with vehicle charging, thereby helping meet user charging needs.

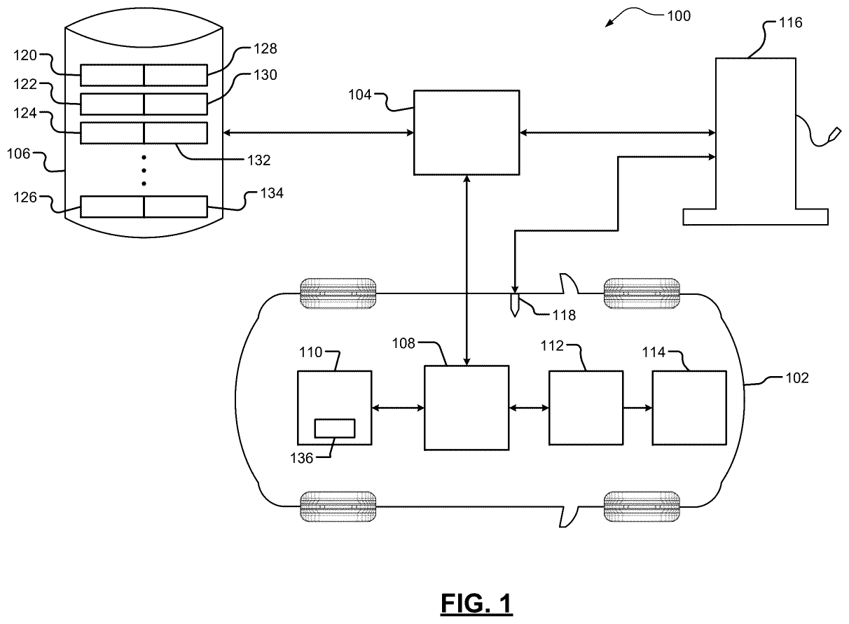

Referring now to FIG. 1, a block diagram of an example vehicle system 100 is presented for improving time duration estimates for charging a battery in a vehicle 102. As shown in FIG. 1, the vehicle system 100 generally includes a control module 104 and a database 106. Additionally, in various embodiments, the vehicle system 100 may optionally include a control module 108, a display module 110, and a charging control module 112 all internal to or positioned in the vehicle 102, and a charging source 116 for providing power to charge a battery module 114 in the vehicle 102 via a charging port 118. In this example, the battery module 114 includes one or more high voltage battery packs each having one or more batteries. In various embodiments, the control module 104 and the database 106 may form a cloud-based architecture for online vehicle charging services.

Although FIG. 1 illustrates the vehicle system 100 as including specific dedicated modules, it should be appreciated that one or more other modules may be employed if desired. For example, any combination of the modules (e.g., the control module 108, the display module 110, and the charging control module 112) and/or the functionality thereof may be integrated into a single module or multiple different modules. Additionally, while the vehicle system 100 is shown as including only one charging source 116, it should be appreciated that the vehicle system 100 may include and/or be in communication with multiple charging sources if desired.

In the example of FIG. 1, the vehicle 102 of FIG. 1 may be any suitable EV, such as a pure EV, a plug-in hybrid EV, etc. Additionally, the vehicle 102 may be an autonomous vehicle, a semi-autonomous vehicle, a non-autonomous vehicle, etc. While the vehicle system 100 of FIG. 1 is shown as interacting with the vehicle 102, it should be appreciated that the vehicle system 100 may be employable with other suitable EVs, autonomous vehicles, semi-autonomous vehicles, non-autonomous vehicles, etc.

In FIG. 1, the control module 104 is in communication with the database 106, the control module 108 in the vehicle 102, and the charging source 116. In such examples, the control module 104 may receive and/or transmit signals between each of the database 106, the control module 108, and the charging source 116 via any suitable wireless and/or wired communication protocol. Additionally, in the vehicle 102, the display module 110 and the charging control module 112 are in communication with the control module 108. These internal modules may receive and/or transmit signals between each other via a network, such as a controller area network (CAN).

The database 106 may be any suitable type of database for storing charging schedule related information. For example, the database 106 may store one or more charging schedules for one or more charging sources including the charging source 116 of FIG. 1. In such examples, each charging schedule may be initially set by a user, a utility company, etc. Each charging schedule includes charging timeslots, where each timeslot specifies an estimated time duration (e.g., a time length) and a corresponding planned charge power value which may vary during a charging session. In such examples, each timeslot includes a start time and an end time which constitute the time duration. In some examples, an initial charge time duration estimate for each timeslot may be fixed based on known charging information, such as a charging power capable of being provided by a charging source (e.g., the charging source 116, the utility company, etc.), an energy needed for charging a vehicle (e.g., the vehicle 102), etc.

Additionally, the database 106 may store compensation factors for planned charge power values, as further explained herein. In such examples, the compensation factors may be stored in an array whose indexes represent different charge power values. For example, in FIG. 1, the database 106 is shown as including multiple compensation factors CF1, CF2, CF3, CFn (represented by boxes 120, 122, 124, 126) and corresponding charge power values PV1, PV2, PV3, PVn (represented by boxes 128, 130, 132, 134).

With continued reference to FIG. 1, the control module 104 determines compensation factors for planned charge power values in the timeslots. As further explained below, each compensation factor is determined based on an error and a system weight. In such examples, the process explained below to determine a compensation factor may be repeated for each timeslot and continuously to update each compensation factor.

In various embodiments, the control module 104 determines the error based on an estimated energy need and an actual energy provided for a particular charging timeslot for charging the battery in the vehicle. More specifically, the control module 104 may determine the estimated energy need and the actual energy, and then determine the error between the estimated energy need and the actual energy.

For instance, the estimated energy provided for the charging timeslot may be determined based on an estimated time duration and a corresponding planned charge power value specific to the charging timeslot. In various embodiments, the control module 104 may determine the estimated energy for a timeslot according to Equation (1) below. In Equation (1), the timeslot estimated energy (e.g., kWh) is calculated by multiplying the estimated time duration (e.g., Hr) and the planned charge power value (e.g., kW). In various embodiments, the estimated time duration and the planned charge power value for the charging timeslot may be received or otherwise obtained from the database 106.

$${Energy}_{Estimated \_ Timeslot} = Estimated Time Duration * Planned Charge Power \qquad Equation ( 1 )$$

Additionally, the actual energy provided during the charging timeslot may be determined based on an actual charge power value and an actual time duration for charging the battery in the vehicle. In such examples, the actual energy is actively determined during charging. In various embodiments, the control module 104 may determine the actual energy for the timeslot according to Equation (2) below. In Equation (2), the timeslot actual energy (e.g., kWh) is calculated by multiplying the actual time duration (e.g., Hr) and the actual charge power value (e.g., kW). In various embodiments, the actual time duration and the actual charge power value for the charging timeslot may be received or otherwise obtained from the vehicle 102, the charging source 116, etc. after a charging session implementing the timeslot. For example, sensors in the vehicle 102 may detect a voltage and current provided to the vehicle 102 from the charging source 116 and the charging time duration. Alternatively, sensors in the charging source 116 may detect a voltage and current provided to the vehicle 102 and the charging time duration. Then, the control module 104 or the control module 108 in the vehicle 102 may calculate the actual charge power provided.

$${Energy}_{Actual \_ Timeslot} = Actual Time Duration * Actual Charge Power \qquad Equation ( 2 )$$

Then, based on the estimated energy and the actual energy, the control module 104 determines the error. In various embodiments, Equation (3) below may be implemented by the control module 104 to determine the error (e.g., a percent error). As shown in Equation (3), the timeslot actual energy from Equation (2) is subtracted from the timeslot estimated energy from Equation (1), and this difference is divided by the timeslot estimated energy, to obtain the error.

$$Error = \frac{{Energy}_{Estimated \_ Timeslot} - {Energy}_{Actual \_ Timeslot}}{{Energy}_{Estimated \_ Timeslot}} \qquad Equation ( 3 )$$

Additionally, the control module 104 determines the system weight for the timeslot. In such examples, the system weight takes into account one or more conditions associated with charging the battery in the vehicle (e.g., the battery module 114 of the vehicle 102). In various embodiments, the conditions may be any suitable environmental and/or system factors. As example only, the conditions may include at least one of a time duration factor (e.g., the timeslot time duration), an energy factor (e.g., energy transferred during the timeslot), a battery temperature factor (e.g., the temperature of the HV battery during charging), a battery state of health (SOH) factor (e.g., the SOH of the HV battery), a charging current type factor (e.g., an AC-DC charge type, a DC charge type, etc.), and a charging location factor. As provided below, the control module 104 may implement a suitable weighting function that can be calibratable and/or adaptable as desired.

For example, Equation (4) below is one example weighting function that may be employed by the control module 104 to determine the system weight. As shown in Equation (4), the system weight is determined by multiplying each factor and its corresponding assigned weight values and then summing the products. In Equation (4), F1, F2, F3, F4, . . . . Fn represent values of factors, such as a time duration factor, an energy factor, a battery temperature factor, a battery SOH factor, a charging current type factor, a charging location factor, etc. as explained above. In some examples, F1, F2, F3, F4, . . . . Fn may range from 0 to 1 or another suitable range of values. Additionally, x1, x2, x3, x4, . . . xn represent the assigned weight values for each factor.

$$System Weight = ( F 1 * x 1 ) + ( F 2 * x 2 ) + ( F 3 * x 3 ) + ( F 4 * x 4 ) + ⋯ ( Fn * xn ) \qquad Equation ( 4 )$$

In such examples, values for each factor may be determined in any suitable manner. For example, some or all of the values may be determined based on lookup tables. As one example, if a time duration factor is employed in the weighting function (e.g., F1 of Equation (4)), the control module 104 may implement a lookup table to determine the value of the time duration factor. For instance, the lookup table may include an array of defined time durations and a corresponding value for each defined time duration. As one example, the array may be ([1, 2, 3, 4, 5], [0.2, 0.4, 0.6, 0.8, 1.0]). As such, in this example, if the timeslot time duration is 2 hours, then the control module 104 uses the value of 0.4 for the time duration factor. Alternatively, if the timeslot time duration is 4 hours, then the control module 104 uses the value of 0.8 for the time duration factor. In this example, longer charge times are more trusted to be stable as represented by increasing values associated with longer durations.

Likewise, the control module 104 may implement similar lookup tables to determine the values of the energy factor and/or the battery temperature factor if employed. For instance, the lookup table for the energy factor may include an array of defined energy amounts (e.g., kWh) and a corresponding value for each defined energy amount. As one example, the energy factor array may be ([20, 40, 60, 80, 100], [0.2, 0.4, 0.6, 0.8, 1.0]) or another suitable array. As such, if the actual energy consumed during the timeslot is, for example, 20 kWh, then the control module 104 uses the value of 0.2 for the energy factor. Additionally, the lookup table for the battery temperature factor may include an array of defined temperatures (e.g., deg C., deg F., etc.) and a corresponding value for each defined temperature. For example, the battery temperature factor array may be ([−20, 0, 20, 40, 60], [0.2, 0.4, 0.6, 0.8, 1.0]) or another suitable array. In this example, if a sensed battery temperature is, for example, 60 deg C., then the control module 104 uses the value of 1.0 for the battery temperature factor.

In other example, some or all of the values for particular factors may be determined according to known functions, based on a defined calibrated value. For instance, if a battery SOH factor is employed in the weighting function (e.g., F1 of Equation (4)), the control module 104 may determine a corresponding value based on defined calibrated values. For example, if the battery SOH is determined to be greater than a defined percent (e.g., 80%, etc.), the control module 104 may use one calibrated value (e.g., 1.0, etc.) for the battery SOH factor. If, however, the SOH is less than or equal to the defined percent, the control module 104 may use another, lower calibrated value (e.g., 0.5, etc.) for the battery SOH factor.

Likewise, if a charging current type factor is employed in the weighting function, the control module 104 may determine a corresponding value based on defined calibrated values. For example, the control module 104 may use a different calibrated value for different types of power sources, such as an AC high voltage source, an AC low voltage source, a DC high voltage source, a DC low voltage source, etc. As another example, the control module 104 may use one calibrated value (e.g., 1.0, etc.) for the charging current type factor if the charging type is AC power or another, lower calibrated value (e.g., 0.5, etc.) if the charging type is DC power.

A similar calibrated determination may be implemented for a charging location factor if desired. For example, if the particular charging location is a frequently visited location (e.g., at a user's house, etc.), the control module 104 may use one calibrated value (e.g., 1.0, etc.) for the charging current type factor. If not, the control module 104 may use another, lower calibrated value (e.g., 0.5, etc.) for the charging current type factor.

In various embodiments, the assigned weight values may be defined values chosen to determine the importance of each factor utilized. For instance, the assigned weight value associated with the time duration factor may be 5%, 10%, 15%, etc., the assigned weight value associated with the energy factor may be 15%, 25%, etc., and so on. In some examples, the sum of each assigned weight value for the factors utilized may equal one, as shown in Equation (5) below. In other examples, the sum may equal another suitable value if desired.

$$x 1 + x 2 + x 3 + x 4 + ⋯ xn = 1 \qquad Equation ( 5 )$$

Then, once the error and the system weight are known, the control module 104 determines a compensation factor for the particular charge power value in a particular timeslot. For example, the control module 104 may implement Equation (6) below to determine a compensation factor (CF). As shown, the compensation factor (CF) is determined by multiplying the error of Equation (3) above and the system weight of Equation (4) above.

$$CF = Error * System Weight \qquad Equation ( 6 )$$

Additionally, in some examples, a compensation factor may have been previously determined for the same charge power value or range. In such examples, the compensation factor maintains a small portion of the previous value in order to converge on a more accurate value. In other words, the control module 104 of FIG. 1 can determine the compensation factor based on a previous compensation factor for the same planned charge power value. As one example, this updated compensation factor may be determined according to Equation (7) below. In Equation (7), CF_{updated} represents the new updated compensation factor value, CFₚᵣₑᵥᵢₒᵤₛ represents the previous compensation factor value (e.g., from the index in the database 106 for the same charge power value or range), and y represents a percent filtered error. In various embodiments, the percent filtered error (y) may change each time a new compensation factor is determined. For instance, for the first update to the compensation factor for a charge power value or range, the percent filtered error may be 5%. Then, for the next update to the compensation factor for the charge power value or range, the percent filtered error may be 3%.

$${CF}_{updated} = ( 1 - y ) * {CF}_{Previous} + Y * CF \qquad Equation ( 7 )$$

Then, the control module 104 stores the compensation factor in the database 106 specific to the planned charge power value in the timeslot. In such examples, the control module 104 may store the compensation factor as an initial compensation factor or store an updated compensation factor (e.g., replace a previous compensation factor). In either case, the control module 104 associates the stored compensation factor with a particular planned charge power value (or range). For example, and as explained above, the control module 104 may insert a new or updated compensation factor value CF1 (in the box 120 of FIG. 1) and associate that value to the charge power value PV1.

In such examples, one particular charge power value (or range) regardless of the timeslot can share the same compensation factor. For example, the charge power values may include 10 KW, 13 KW, 15 kW, etc. for various timeslots having different estimated time durations. In this example, all 10 KW timeslots share the same compensation factor, all 13 KW timeslots share the same compensation factor, and all 15 kW timeslots share the same compensation factor. Additionally, the compensation factors for the charge power values are different. In other words, the compensation factor for the 10 kW timeslots is different than the compensation factors for the 13 KW timeslots and the 15 kW timeslots, and the compensation factor for the 13 KW timeslots is different than the compensation factor for the 15 kW timeslots.

In various embodiments, the new or updated compensation factor may be utilized to fine tune systems parameters. For example, in some embodiments, the control module 104 may adjust values for the factors and/or values for the assigned weight values for the weighting function of Equation (4) and/or another suitable weighting function.

Then, prior to a subsequent charging session, the control module 104 may utilize one of the stored compensation factors to determine an adjusted time duration for charging a battery in a vehicle, such as the battery module 114 of the vehicle 102. For example, the control module 104 can select one of the stored compensation factors from the database 106 based on a subsequent planned charge power value for charging the battery module 114 of the vehicle 102. For instance, prior to the subsequent charging session, the control module 104 may receive one or more inputs indicating an available charge power. In such examples, the charging source 116 may transmit a signal to the control module 104 indicating that it can provide up to 10 KW of charge power. Additionally, a charging schedule may be set to 15 kW of charge power. In such examples, if the vehicle 102 is at the charging source 116 for recharging the battery module 114, the control module 104 may select a minimum value (e.g., 10 KW) as the subsequent planned charge power value. The control module 104 can then select the stored compensation factor from the database 106 associated with the subsequent planned charge power value.

Next, the control module 104 can determine an adjusted energy based on the estimated energy and the selected compensation factor. For example, the adjusted energy may be determined according to Equation (8) below. In Equation (8), the adjusted energy (Energy_{Adjusted}) for the timeslot is determined based on an estimated energy for that timeslot associated with the subsequent planned charge power value and the selected compensation factor (CF_{Selected}). In various embodiments, the timeslot estimated energy may be determined in Equation (1) above and subsequently stored and associated with a planned charge power value.

$${Energy}_{Adjusted \_ Timeslot} = {Energy}_{Estimated \_ Timeslot} * ( 1 - {CF}_{Selected} ) \qquad Equation ( 8 )$$

Then, an adjusted time duration for the timeslot to charge the battery module 114 in the vehicle 102 may be determined based on the adjusted energy. For example, the control module 104 may implement Equation (9) below to determine the adjusted time duration for the timeslot. In Equation (9), the adjusted time duration for the timeslot is determined by dividing the adjusted energy for the timeslot (Energy_{Adjusted_Timeslot}) taken from Equation (8) above by a charge power. In such examples, the charge power may be known or determined based on a sensed voltage and current.

$$Time {Duration}_{Adjusted \_ Timeslot} = \frac{{Energy}_{Adjusted}}{Charge Power} \qquad Equation ( 9 )$$

Once determined, the adjusted time duration estimate may be used in various applications. For example, the charging control module 112 in the vehicle 102 may receive the adjusted time duration from the control module 104 (e.g., via the control module 108). In such examples, the charging control module 112 may schedule a charging session for the battery module 114 based on the adjusted time duration, and then automatically control charging of the battery module 114 in response to the scheduled charging session.

For example, the charging control module 112 may schedule a charging session for the battery module 114 according to a defined charge competition time for the battery module 114. In such examples, the charging control module 112 can determine a charging start time based on the adjusted time duration to ensure the battery module 114 is charged (e.g., fully charged) at the charge competition time. As one example, the charge competition time may be 5 PM and the adjusted time duration may be 2.5 hours. In this example, the charging control module 112 determines a charging start time of 2:30 PM or earlier to ensure the battery module 114 is charged.

In other examples, the charging control module 112 may schedule a charging session for the battery module 114 according to desired times to charge the battery module 114. For example, a user may desire to charge the battery module 114 during off-peak hours for a power system (e.g., utility system) to reduce costs. In such examples, the off-peak hours may be during the night, such as between 9 PM and 5 AM. As such, the charging control module 112 may schedule a charging session for the battery module 114 to occur been 9 PM and 5 AM.

Further, in some examples, the display module 110 in the vehicle 102 may receive the adjusted time duration from the control module 104 (e.g., via the control module 108) and then display the adjusted time duration for charging the battery module 114. In such examples, the display module 110 may include a middle console display, a heads-up display, etc. viewable by a user.

In various embodiments, the display module 110 may also display an input selectable by a user to indicate approval of the adjusted time duration. Then, in response to the user selecting the input indicating approval of the adjusted time duration, the charging control module 112 controls charging of the battery module 114. For example, in FIG. 1, the display module 110 may display an input 136 which the user may touch or otherwise select to approve of or deny the adjusted time duration. If the user approves the adjusted time duration, the display module 110 may transmit a signal to the charging control module 112 (via the control module 108) to initial charging of the battery module 114.

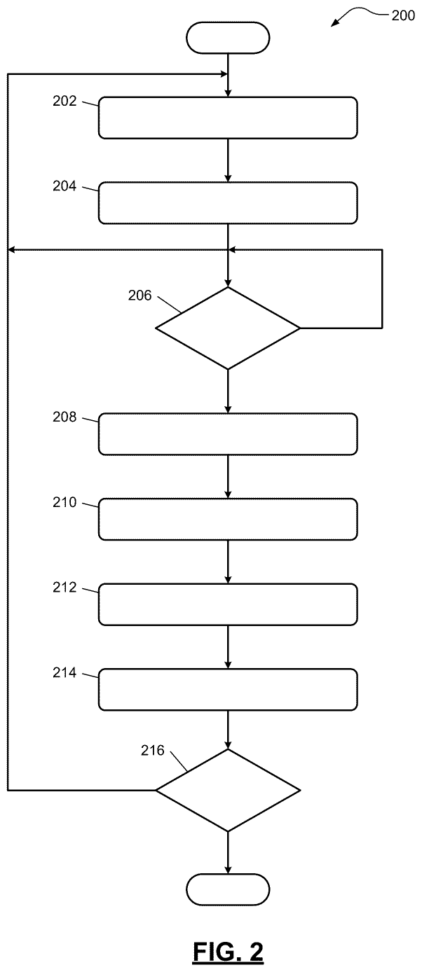

FIGS. 2-6 illustrate example charging control methods 200, 300, 400, 500 employable by the vehicle system 100 of FIG. 1 for improving time duration estimates for charging a battery in a vehicle, such as the battery module 114 in the vehicle 102. Although the example charging control methods 200, 300, 400, 500 are described in relation to the vehicle system 100 of FIG. 1 including the control module 104, any one of the charging control methods 200, 300, 400, 500 may be employable by another suitable system and/or module.

As shown in FIG. 2, the charging control method 200 begins at 202 by determining a compensation factor associated with a charge power value. For example, and as explained above, the control module 104 may implement Equation (6) above to determine the compensation factor based on a system weight and an error between an estimated energy provided for a charging timeslot and an actual energy provided during the charging timeslot for charging the battery module 114 in the vehicle 102. In such examples, the error and the system weight may be determined according to Equations (3) and (4) above, respectively. In other examples, the compensation factor may be an updated value based on a previous compensation factor, as explained above relative to Equation (7). The charging control method 200 then proceeds to 204.

At 204, the control module 104 stores the new or updated compensation factor in the database 106. In such examples, the control module 104 stores the compensation factor and associates the compensation factor with a particular planned charge power value (or range), as explained above. In such examples, one particular charge power value (or range) regardless of the timeslot can be associated with and share the same compensation factor, as explained above. The charging control method 200 then may return to 202 to determine and store another compensation factor (e.g., for each timeslot of a charging schedule) if desired and/or proceed to 206.

At 206, the control module 104 determines whether a charging event or session is imminent, requested, etc. For example, the control module 104 may receive a signal from the control module 108 in the vehicle 102, the charging source 116, etc. indicating a desired charging session. If no at 206, the charging control method 200 returns to 206. If yes at 206, the charging control method 200 proceeds to 208.

At 208, the control module 104 identifies a charge power value for charging to the battery module 114. This charge power value may be determined based on information provided in a charging schedule, provided by the charging source 116, etc. as explained above. The charging control method 200 then proceeds to 210, where the control module 104 selects one of the stored compensation factors from the database 106 associated with the planned charge power value of 208. Then, the charging control method 200 proceeds to 212.

At 212, the control module 104 determines an adjusted time duration for charging the battery module 114 based on the selected compensation factor. For example, and as explained above, the control module 104 may implement Equation (8) above to determine an adjusted energy based on the selected compensation factor, and then implement Equation (9) above to determine the adjusted time duration based on the adjusted energy. The charging control method 200 then proceeds to 214.

At 214, charging of the battery module 114 may begin. For example, and as explained above, the charging control module 112 in the vehicle 102 may receive the adjusted time duration from the control module 104 and then control charging of the battery module 114 based on the adjusted time duration. In such examples, the charging control module 112 may schedule a charging session based on the adjusted time duration, as explained above. The charging control method 200 then proceeds to 216. At 216, the control module 104 determines whether an application for improving adjusted time durations is disabled. If no at 216, the charging control method 200 returns to 202 to continue determining and storing compensation factors. If yes at 216, the charging control method 200 ends as shown in FIG. 2.

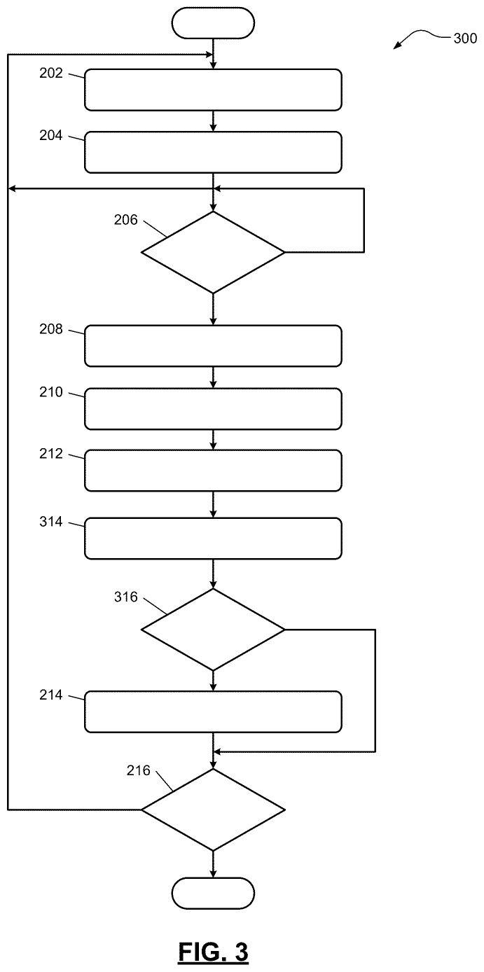

The charging control method 300 of FIG. 3 is similar to the charging control method 200 of FIG. 2 but includes additional steps. For example, as shown in FIG. 3, the charging control method 300 begins at 202 of FIG. 2, and then proceeds to 204, 206, 208, 210, 212 of FIG. 2, all of which are explained above. Then, after an adjusted time duration for charging the battery module 114 is determined at 212, the charging control method 300 proceeds to 314.

At 314, the display module 110 displays the adjusted time duration and a selectable input to indicate approval of the adjusted time duration. The charging control method 300 then proceeds to 316, where the control module 108 determines whether the input has been selected to approve the adjusted time duration. For example, once displayed, a user may select the input to approve of the adjusted time duration with respect to an upcoming charging session. In such examples, the display module 110 may provide a signal to the control module 108 indicating approval of the adjusted time duration. If no at 316, the charging control method 300 proceeds to 216 of FIG. 2 explained above. If yes at 316, the charging control method 300 proceeds to 214 of FIG. 2 where the charging control module 112 controls charging of the battery module 114 based on the adjusted time duration. The charging control method 300 then proceeds to 216 of FIG. 2 explained above.

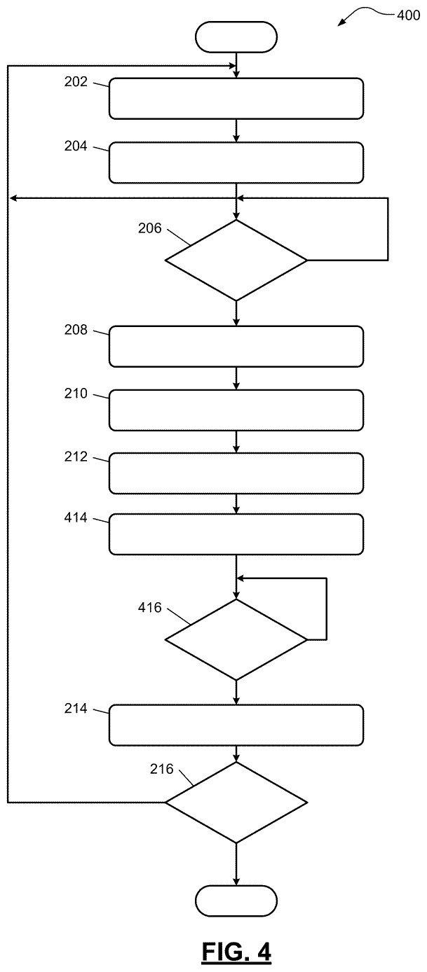

The charging control method 400 of FIG. 4 is similar to the charging control methods 200, 300 of FIGS. 2-3 but includes alternative steps. For example, as shown in FIG. 4, the charging control method 400 begins at 202 of FIG. 2, and then proceeds to 204, 206, 208, 210, 212 of FIG. 2, all of which are explained above. Then, after an adjusted time duration for charging the battery module 114 is determined at 212, the charging control method 400 proceeds to 414.

At 414, a charging session is scheduled based on the determined adjusted time duration. For example, and as explained above, the charging control module 112 in the vehicle 102 may receive the adjusted time duration from the control module 104 (via the control module 108) and then schedule a charging session based on the adjusted time duration. In some examples, the charging control module 112 can schedule the charging session to ensure the battery module 114 is charged by a defined charge competition time, ensure the battery module 114 is charged during off-peak hours, etc. as explained above. The charging control method 400 then proceeds to 416.

At 416, the charging control module 112 determines whether to begin charging based on the scheduled charging session. If no, the charging control method 400 returns to 416. If yes, the charging control method 400 proceeds to 214 of FIG. 2 where the charging control module 112 controls charging of the battery module 114. The charging control method 400 then proceeds to 216 of FIG. 2 explained above.

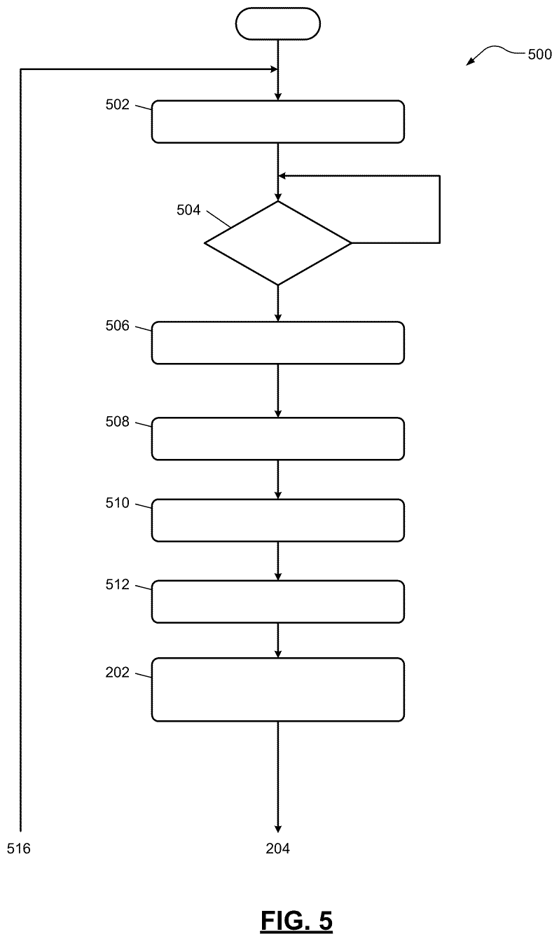

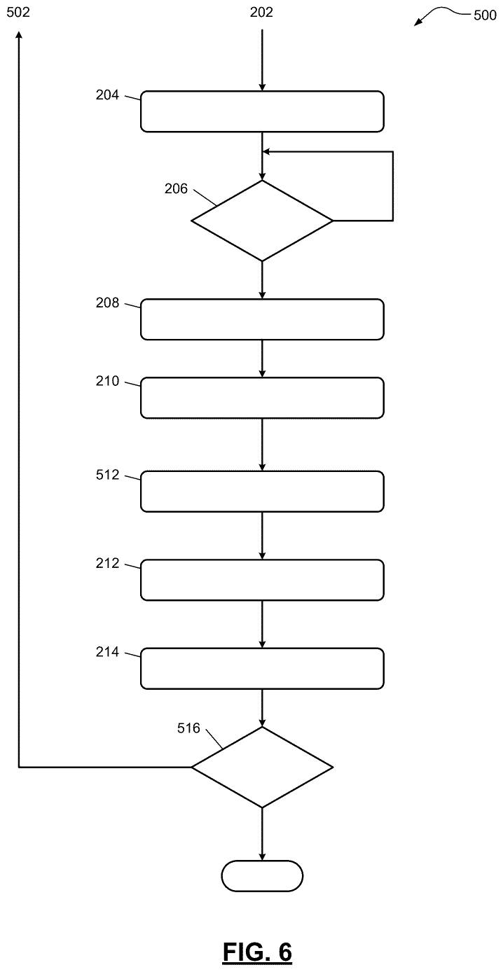

The charging control method 500 of FIGS. 5-6 is similar to the charging control method 200 of FIG. 2 but includes additional steps. As shown in FIG. 5, the charging control method 500 begins at 502 where the control module 104 determines an estimated energy provided for a charging timeslot. As explained above, the control module 104 may implement Equation (1) above to determine the estimated energy based on an estimated time duration and a planned charge power value for the charging timeslot. In such examples, the estimated time duration and the planned charge power value are obtained from the database 106. The charging control method 500 then proceeds to 504.

At 504, the control module 104 determines whether a charging event or session is occurring. For example, the control module 104 may receive a signal from the control module 108 in the vehicle 102, the charging source 116, etc. indicating such information. If no at 504, the charging control method 500 returns to 504. If yes at 504, the charging control method 500 proceeds to 506, where charging of the battery module 114 begins based on, for example, control of the charging control module 112. The charging control method 500 then proceeds to 508.

At 508, the control module 104 determines an actual energy provided during charging timeslot. Here, the actual energy is actively determined during charging of the battery module 114. As explained above, the control module 104 may implement Equation (2) above to determine the actual energy based on an actual time duration and an actual charge power value. Next, the charging control method 500 proceeds to 510.

At 510, the control module 104 determines an error between the estimated energy and the actual energy. In various embodiments, the control module 104 may implement Equation (3) above for this determination. The charging control method 500 then proceeds to 512.

At 512, the control module 104 determines a system weight based on one or more conditions associated with charging the battery module 114 in the vehicle 102. In various embodiments, the conditions may include, for example, any suitable environmental and/or system factors, such as a time duration factor, an energy factor, a battery temperature factor, a battery SOH factor, a charging current type factor, a charging location factor, etc. To determine the system weight, the control module 104 may implement a suitable weighting function that can be calibratable and/or adaptable as desired. One example weighting function is Equation (4) above. Then, the charging control method 500 then proceeds to 202 of FIG. 2.

At 202, the control module 104 determines a compensation factor associated with the charge power value for the charging timeslot. For example, and as explained above, the control module 104 may implement Equation (6) above to determine the compensation factor based on the error from 510 and the system weight from 512. In other examples, the compensation factor may be an updated value based on a previous compensation factor, as explained above relative to Equation (7).

Then, as shown in FIG. 6, the charging control method 500 proceeds to 204, 206, 208, 210 of FIG. 2, all of which are explained above. After a stored compensation factor is selected from the database 106 at 210, the charging control method 500 proceeds to 512 of FIG. 6.

At 512, the control module 104 determines an adjusted energy for charging the battery module 114 in the vehicle 102. As explained above, the control module 104 may implement Equation (8) above to determine the adjusted energy based on the estimated energy and the selected compensation factor. Then, the charging control method 500 proceeds to 212 of FIG. 2, where the control module 104 determines an adjusted time duration for charging the battery module 114 as explained above. The charging control method 500 then proceeds to 516.

At 516, the control module 104 determines whether an application for improving adjusted time durations is disabled. If no at 516, the charging control method 500 returns to 502 of FIG. 5. If yes at 516, the charging control method 500 ends as shown in FIG. 6.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle system for improving time duration estimates for charging a battery in a vehicle based on a charging schedule including charging timeslots, each charging timeslot having an estimated time duration and a corresponding planned charge power value, the vehicle system comprising:
a database; and
a control module in communication with the database, the control module configured to:
determine a plurality of compensation factors for a plurality of planned charge power values, each compensation factor determined based on a system weight and an error between an estimated energy provided for a charging timeslot of the charging timeslots and an actual energy provided during the charging timeslot for charging the battery in the vehicle;
store, in the database, each of the plurality of compensation factors specific to one of the planned charge power values;
select one of the stored compensation factors from the database based on a subsequent planned charge power value for charging the battery in the vehicle; and
determine an adjusted time duration for charging the battery in the vehicle based on the selected compensation factor.

2. The vehicle system of claim 1, further comprising a vehicle charging control module positioned in the vehicle and in communication with the control module, the vehicle charging control module is configured to:
schedule a charging session for the battery in the vehicle based on the adjusted time duration; and
control charging of the battery in response to the scheduled charging session.

3. The vehicle system of claim 2, wherein the vehicle charging control module is configured to schedule the charging session based on the adjusted time duration and a defined charge competition time for the battery.

4. The vehicle system of claim 2, wherein the vehicle charging control module is configured to schedule the charging session based on the adjusted time duration and off-peak hours for a power system to charge the battery.

5. The vehicle system of claim 1, further comprising a display module positioned in the vehicle and in communication with the control module, the display module configured to:
receive the adjusted time duration for charging the battery in the vehicle; and
display the adjusted time duration.

6. The vehicle system of claim 5, further comprising a vehicle charging control module positioned in the vehicle, wherein:
the display module is configured to display an input selectable by a user to indicate approval of the adjusted time duration; and
the vehicle charging control module is configured to control charging of the battery in the vehicle in response to the user selecting the input indicating approval of the adjusted time duration.

7. The vehicle system of claim 1, wherein the control module is configured to determine at least one of the compensation factors based on a previous compensation factor for the same planned charge power value.

8. The vehicle system of claim 1, wherein the control module is configured to:
determine an adjusted energy based on the estimated energy and the selected compensation factor; and
determine the adjusted time duration for charging the battery in the vehicle based on the adjusted energy.

9. The vehicle system of claim 1, wherein the control module is configured to determine the system weight based on one or more conditions associated with charging the battery in the vehicle.

10. The vehicle system of claim 9, wherein the one or more conditions includes at least one of a time duration factor, an energy factor, a battery temperature factor, a battery state of health factor, a charging current type factor, and a charging location factor.

11. The vehicle system of claim 9, wherein the control module is configured to assign weight values for the one or more conditions and determine the system based on the one or more conditions and their assigned weight values.

12. The vehicle system of claim 11, wherein the control module is configured to:
determine the estimated energy provided for the charging timeslot based on the estimated time duration and the corresponding planned charge power value specific to the charging timeslot; and
determine the actual energy provided during the charging timeslot based on an actual charge power value and an actual time duration for charging the battery in the vehicle.

13. A vehicle system for improving time duration estimates for charging a battery in a vehicle based on a charging schedule including charging timeslots, each charging timeslot having an estimated time duration and a corresponding planned charge power value, the vehicle system comprising:
a database configured to store a plurality of compensation factors for a plurality of planned charge power values; and
a control module in communication with the database, the control module configured to:
determine an estimated energy provided for a charging timeslot of the charging timeslots based on the estimated time duration and the corresponding planned charge power value specific to the charging timeslot;
determine an actual energy provided during the charging timeslot based on an actual charge power value and an actual time duration for charging the battery in the vehicle;
determine an error between the estimated energy and the actual energy;
determine a system weight based on one or more conditions associated with charging of a battery in the vehicle;
determine a compensation factor for the planned charge power value based on the system weight and the error;
store, in the database, the compensation factor specific to the planned charge power value;
select one of the stored compensation factors from the database based on a subsequent planned charge power value;
determine an adjusted energy based on the estimated energy and the selected compensation factor; and
determine an adjusted time duration for the subsequent planned charge power value based on the adjusted energy.

14. The vehicle system of claim 13, further comprising a vehicle charging control module positioned in the vehicle and in communication with the control module, the vehicle charging control module configured to:
schedule a charging session for the battery in the vehicle based on the adjusted time duration; and
control charging of the battery in response to the scheduled charging session.

15. The vehicle system of claim 14, wherein the vehicle charging control module is configured to schedule the charging session based on the adjusted time duration and one of a defined charge competition time for the battery or off-peak hours for a power system to charge the battery.

16. The vehicle system of claim 13, further comprising:
a display module positioned in the vehicle and in communication with the control module, the display module configured to receive the adjusted time duration for charging the battery in the vehicle, and display the adjusted time duration and an input selectable by a user to indicate approval of the adjusted time duration; and
a vehicle charging control module positioned in the vehicle and in communication with the control module, the vehicle charging control module configured to control charging of the battery in the vehicle in response to the user selecting the input indicating approval of the adjusted time duration.

17. The vehicle system of claim 13, wherein the control module is configured to determine the compensation factor based on a previous compensation factor specific to the planned charge power value.

18. A charging control method for improving time duration estimates for charging a battery in a vehicle based on a charging schedule including charging timeslots, each charging timeslot having an estimated time duration and a corresponding planned charge power value, the charging control method comprising:
determining a plurality of compensation factors for a plurality of planned charge power values, each compensation factor determined based on a system weight and an error between an estimated energy provided for a charging timeslot of the charging timeslots in the charging schedule and an actual energy provided during the charging timeslot for charging the battery in the vehicle;
storing, in a database, each of the plurality of compensation factors specific to one of the planned charge power values;
selecting one of the stored compensation factors from the database based on a subsequent planned charge power value for charging the battery in the vehicle;
determining an adjusted time duration for charging the battery in the vehicle based on the selected compensation factor; and
charging of the battery in the vehicle based on the adjusted time duration.

19. The charging control method of claim 18, wherein:
the charging control method further includes displaying the adjusted time duration and an input selectable by a user to indicate approval of the adjusted time duration; and
charging of the battery in the vehicle includes charging of the battery in response to the input indicating approval of the adjusted time duration.

20. The charging control method of claim 18, wherein:
the charging control method further includes scheduling a charging session for the battery in the vehicle based on the adjusted time duration and one of a defined charge competition time for the battery or off-peak hours for a power system to charge the battery; and
charging of the battery in the vehicle includes charging of the battery in the vehicle controlling charging of the battery in response to the charging session.
